(19) United States
(12) Patent Application Publication
(10) Pub. No.: US 2019/0283741 A1
(43) Pub. Date: Sep. 19, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Akihiro Toda, Wako-shi (JP); Yugo Ueda, Wako-shi (JP); Dan Umeda, Wako-shi (JP); Yuki Motegi, Tokyo (JP); Chie Sugihara, Tokyo (JP)

(21) Appl. No.: 16/296,322

(22) Filed: Mar. 8, 2019

(30) Foreign Application Priority Data
Mar. 15, 2018 (JP) 2018-047992

(51) Int. Cl. B60W 30/09; G05D 1/00; G05D 1/02; B60W 10/20

(52) U.S. Cl. CPC B60W 30/09; G05D 1/0088; G05D 1/0289; B60W 2550/20; B60W 2550/14; B60W 2710/20; B60W 2720/106; B60W 10/20

(57) ABSTRACT

A vehicle control device 100 includes a recognizer 130 which recognizes a surrounding situation of a host vehicle, and driving controllers 140 and 160 which control acceleration or deceleration and steering of the host vehicle on the basis of the surrounding situation recognized by the recognizer, in which a driving controller determines whether another vehicle enters in front of the host vehicle according to a movement of the another vehicle proceeding or intending to proceed in a direction which intersects with a traveling direction of the host vehicle recognized by the recognizer, and causes the host vehicle to decelerate or stop when it is determined that the another vehicle enters in front of the host vehicle.

### CROSS-REFERENCE TO RELATED APPLICATION

Priority is claimed on Japanese Patent Application No. 2018-047992, filed Mar. 15, 2018, the content of which is incorporated herein by reference.

### BACKGROUND

### Field of the Invention

The present invention relates to a vehicle control device, a vehicle control method, and a storage medium.

### Description of Related Art

In recent years, researches on automatic control of a vehicle have been performed. In relation to this, a technology of adjusting the inter-vehicle distance with respect to a preceding vehicle such that it is large when there is another vehicle predicted to enter in front of a host vehicle at a junction of a road is known (refer to, for example, Japanese Unexamined Patent Application, First Publication No. 2013-177054).

### SUMMARY

However, in the conventional technology, determination is performed only for other vehicles traveling through the junction of a road, and not for the entry of other vehicles from areas other than roads such as shops and the like.

As a result, there is a possibility that the entry of other vehicles that are stopped may not be able to be determined and the host vehicle may not be able to travel smoothly.

Aspects of the present invention have been made in consideration of such circumstances, and an object thereof is to provide a vehicle control device, a vehicle control method, and a storage medium which can cause a host vehicle to smoothly travel in various aspects.

A vehicle control device, a vehicle control method, and a storage medium according to the present invention have adopted the following configuration.

(1): A vehicle control device according to one aspect of the present invention is a vehicle control device which includes a recognizer configured to recognize a surrounding situation of a host vehicle, and a driving controller configured to control acceleration or deceleration and steering of the host vehicle on the basis of a surrounding situation recognized by the recognizer, in which the recognizer recognizes another vehicle proceeding or intending to proceed in a first direction which intersects with a traveling direction of the host vehicle, and the driving controller determines whether another vehicle proceeding or intending to proceed in the first direction enters in front of the host vehicle on the basis of a movement of the another vehicle, and causes the host vehicle to decelerate or stop when it is determined that the another vehicle enters in front of the host vehicle.

(2): In the aspect of (1) described above, when the recognizer recognizes that the another vehicle proceeding or intending to proceed in the first direction has moved after a preceding vehicle traveling in front of the host vehicle passes in front of the another vehicle, the driving controller determines that the another vehicle enters in front of the host vehicle, and causes the host vehicle to decelerate or stop.

(3): In the aspect of (1) described above, when the recognizer recognizes that the another vehicle proceeds and a distance between a first position at which the another vehicle is predicted to enter into a road and the host vehicle is equal to or greater than a predetermined distance, the driving controller determines that the another vehicle enters in front of the host vehicle and causes the host vehicle to decelerate or stop.

(4): In the aspect of (3) described above, when it is determined whether to cause a preceding vehicle traveling in front of the host vehicle to decelerate or stop within a predetermined distance from the first position after the preceding vehicle passes through the first position, and a positive determination is obtained by the recognizer, the driving controller causes the host vehicle to decelerate or stop such that the another vehicle enters in front of the host vehicle.

(5): In the aspect of (1) described above, the driving controller determines whether to cause the host vehicle to decelerate or stop according to a distance between a following vehicle traveling behind the host vehicle and the host vehicle.

(6): In the aspect of (1) described above, the vehicle control device further includes an outputter configured to output information, in which the driving controller outputs information prompting the another vehicle to enter in front of the host vehicle via the outputter at the time of causing the host vehicle to decelerate.

(7): In the aspect of (3) described above, when the recognizer recognizes another vehicle in a state in which the another vehicle travels in a second mode in which a second predetermined condition is set to make it easier to cause the another vehicle to enter than in a first mode in which the another vehicle is caused to enter when a first condition is satisfied, the driving controller causes the host vehicle to decelerate or stop such that the another vehicle enters in front of the host vehicle on the basis of the second predetermined condition.

(8): A vehicle control method according to another aspect of the present invention is a vehicle control method which causes a computer to recognize a surrounding situation of a host vehicle, control acceleration or deceleration and steering of the host vehicle on the basis of a recognized surrounding situation, recognize another vehicle proceeding or intending to proceed in a first direction which intersects with a traveling direction of the host vehicle, determine whether the another vehicle enters in front of the host vehicle on the basis of a movement of the recognized another vehicle proceeding or intending to proceed in the first direction, and decelerate or stop the host vehicle when it is determined that the another vehicle enters in front of the host vehicle.

(9): A storage medium according to still another aspect of the present invention is a computer-readable non-transitory storage medium which stores a program causing a computer to recognize a surrounding situation of a host vehicle, control acceleration or deceleration and steering of the host vehicle on the basis of a recognized surrounding situation, recognize another vehicle proceeding or intending to proceed in a first direction which intersects with a traveling direction of the host vehicle, determine whether the another vehicle enters in front of the host vehicle on the basis of a movement of the recognized another vehicle proceeding or intending to proceed in the first direction, and cause the host vehicle to decelerate or stop when it is determined that the another vehicle enters in front of the host vehicle.

According to the aspects of (1) to (9) described above, it is possible to cause a host vehicle to travel smoothly in various aspects.

According to the aspect of (5) described above, it is also possible to cause a following vehicle of the host vehicle to travel smoothly.

According to the aspects of (6) and (7) described above, it is also possible to cause other vehicles to travel smoothly.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram which shows an example of another vehicle recognized by another vehicle recognizer.

FIG. 4 is a diagram which shows a state in which another vehicle enters behind a preceding vehicle of a host vehicle M.

FIG. 5 is a diagram which shows an example of a state in which a preceding vehicle stops after passing a front of another vehicle.

FIG. 6 is a diagram which shows a state in which a following vehicle of the host vehicle M and another vehicle exist.

FIG. 7 is a flowchart which shows an example of a flow of processing executed in an automated driving control device.

FIG. 8 is a diagram which shows an example of a hardware configuration of the automated driving control device of the embodiment.

### DETAILED DESCRIPTION OF THE INVENTION

Hereinafter, an embodiment of a vehicle control device, a vehicle control method, and a storage device of the present invention will be described with reference to the drawings. In the following description, a case in which left-handed traffic regulations are applied will be described, but, when a law of a right-hand traffic is applied, the left and right may be reversed.

[Overall Configuration]

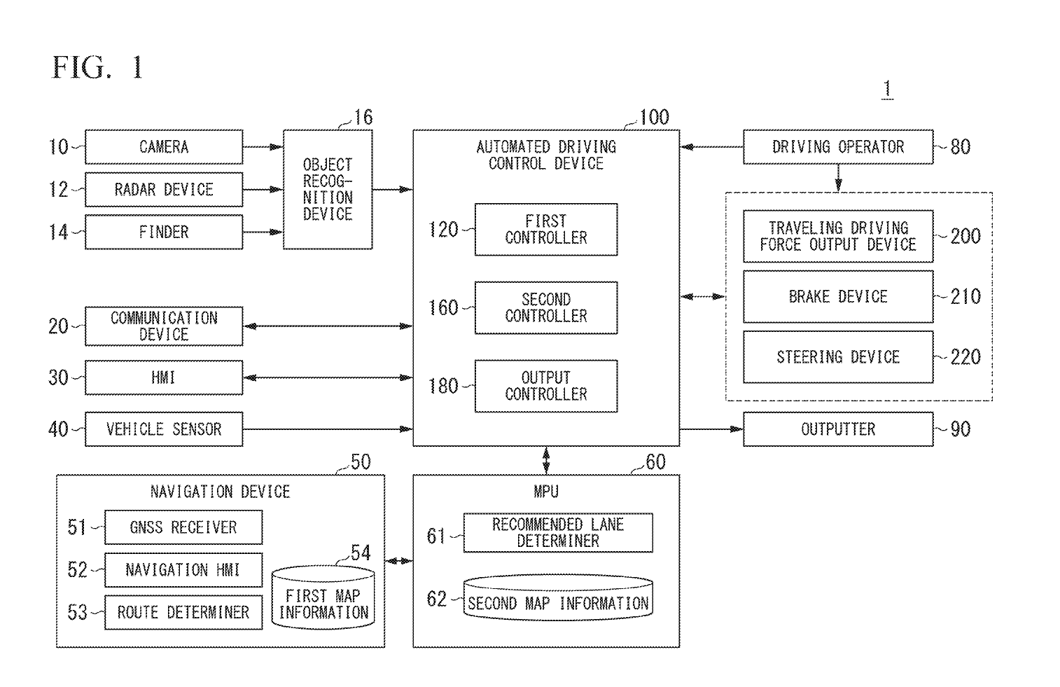

FIG. 1 is a configuration diagram of a vehicle system 1 using a vehicle control device according to an embodiment. A vehicle on which the vehicle system 1 is mounted is, for example, a vehicle such as a two-wheeled vehicle, a three-wheeled vehicle, a four-wheeled vehicle, or the like, and the drive source is an internal combustion engine such as a diesel engine or a gasoline engine, an electric motor, or a combination thereof. The electric motor operates using electric power generated by a generator connected to the internal combustion engine, or discharge power of a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an outputter 90, an automated driving control device 100 (vehicle control device), a traveling driving force output device 200, a brake device 210, and a steering device 220. These devices and apparatuses are connected to one another by a multiplex communication line such as a controller area network (CAN) communication line, a serial communication line, a wireless communication network, or the like. The constituents shown in FIG. 1 are merely an example, and a part of the constituents may be omitted, and furthermore other constituents may also be added.

The camera 10 is, for example, a digital camera using a solid-state imaging device such as a charge coupled device (CCD) or a complementary metal oxide semiconductor (CMOS). The camera 10 is attached to an arbitrary place of the vehicle (hereinafter, referred to as a host vehicle M) on which the vehicle system 1 is mounted. In a case of imaging in front, the camera 10 is attached to an upper portion of the front windshield, a rear surface of the windshield rearview mirror, or the like. For example, the camera 10 periodically repeats imaging the surroundings of the host vehicle M. The camera 10 may be a stereo camera.

The radar device 12 emits radio waves such as millimeter waves around the host vehicle M, and detects at least a position (distance to and direction) of an object by detecting radio waves (reflected waves) reflected by the object. The radar device 12 is attached to an arbitrary place of the host vehicle M. The radar device 12 may detect the position and the speed of the object according to a frequency modulated continuous wave (FM-CW) method.

The finder 14 is light detection and ranging (LIDAR) finder. The finder 14 emits light around the host vehicle M and measures scattered light. The finder 14 detects a distance to an object on the basis of time from light emission to light reception. The emitted light is, for example, a pulsed laser light. The finder 14 is attached to an arbitrary place of the host vehicle M.

The object recognition device 16 recognizes the position, type, speed, and the like of the object by performing sensor fusion processing on a result of detection by some or all of the camera 10, the radar device 12, and the finder 14. The object recognition device 16 outputs a result of the recognition to the automated driving control device 100. The object recognition device 16 may output results of the detection of the camera 10, the radar device 12, and the finder 14 to the automated driving control device 100 as they are. The object recognition device 16 may be omitted from the vehicle system 1.

The communication device 20 communicates with another vehicle existing around the host vehicle M using a cellular network, a Wi-Fi network, Bluetooth (registered trademark), dedicated short range communication (DSRC), or the like, or communicates with various server devices via a radio base station.

The HMI 30 presents various types of information to an occupant of the host vehicle M and receives an input operation by the occupant. The HMI 30 includes various display devices, a speaker, a buzzer, a touch panel, a switch, a key, and the like.

The vehicle sensor 40 includes a vehicle speed sensor that detects the speed of the host vehicle M, an acceleration sensor that detects the acceleration, a yaw rate sensor that detects the angular speed around a vertical axis, a direction sensor that detects the orientation of the host vehicle M, and the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the host vehicle M on the basis of a signal received from a GNSS satellite. The position of the host vehicle M may be identified or complemented according to an inertial navigation system (INS) using an output of the vehicle sensor 40. The navigation HMI 52 includes a display device, a speaker, a touch panel, a key, and the like. The navigation HMI 52 may be partly or entirely the same as the HMI 30 described above. For example, the route determiner 53 determines a route (hereafter, referred to as route on a map) from the position (or an arbitrary input position) of the host vehicle M identified by the GNSS receiver 51 to a destination input by an occupant using the navigation HMI 52 with reference to the first map information 54. The first map information 54 is information in which a road shape is expressed, for example, by a link indicating a road and nodes connected by a link. The first map information 54 may include a curvature of a road, point of interest (POI) information, and the like.

A route on a map is output to the MPU 60. The navigation device 50 may perform route guidance using the navigation HMI 52 on the basis of the route on a map. The navigation device 50 may be realized by a function of a terminal device such as a smartphone or a tablet terminal possessed by an occupant, for example. The navigation device 50 may transmit a current position and a destination to a navigation server via the communication device 20 and acquire a route equivalent to the route on a map from the navigation server.

The MPU 60 includes, for example, a recommended lane determiner 61, and holds second map information 62 in a storage device such as an HDD or a flash memory. The recommended lane determiner 61 divides the route on a map provided from the navigation device 50 into a plurality of blocks (for example, divides the route every 100 [m] in a vehicle traveling direction), and determines a recommended lane for each block by referring to the second map information 62. The recommended lane determiner 61 makes a decision on which numbered lane from the left to travel.

The recommended lane determiner 61 determines a recommended lane such that the host vehicle M can travel on a reasonable route for proceeding to a branch destination when there is a branch place on the route on a map.

The second map information 62 is map information with higher accuracy than the first map information 54. The second map information 62 includes, for example, information on a center of a lane, information on boundaries of a lane, or the like. The second map information 62 may include road information, traffic regulations information, address information (address/zip code), facility information, telephone number information, and the like. The second map information 62 may be updated at any time when the communication device 20 communicates with another device.

The driving operator 80 includes, for example, an accelerator pedal, a brake pedal, a shift lever, a steering wheel, a variant steer, a joystick, and other operators. The driving operator 80 is attached to a sensor for detecting an amount of operation or the presence or absence of an operation, and a result of the detection is output to an automated driving control device 100, or some or all of a traveling driving force output device 200, a brake device 210, and a steering device 220.

For example, the outputter 90 outputs information given from the host vehicle to another vehicle. The outputter 90 is controlled by, for example, the automated driving control device 100, and outputs information prompting another vehicle to enter into a road when a deceleration operation is performed on the host vehicle as an avoidance operation as described below. The outputter 90 includes, for example, light, a horn, a speaker, an external display device, a communication device 20, and the like. The outputter 90 outputs light, sound, a message display, transmission information, and the like to another vehicle.

The automated driving control device 100 includes, for example, a first controller 120, a second controller 160, and an output controller 180. Each of the first controller 120, the second controller 160, and the output controller 180 is realized by, for example, a hardware processor such as a central processing unit (CPU) executing a program (software). Some or all of these components may be realized by hardware (circuit unit; including circuitry) such as a large scale integration (LSI), an application specific integrated circuit (ASIC), a field-programmable gate array (FPGA), a graphics processing unit (GPU), or may be realized by combination of software and hardware.

The program may be previously stored in a storage device such as the HDD or flash memory of the automated driving control device 100 or stored in a removable storage medium such as a DVD or a CD-ROM, and may also be installed in the HDD or flash memory of the automated driving control device 100 when the storage medium is mounted on a drive device.

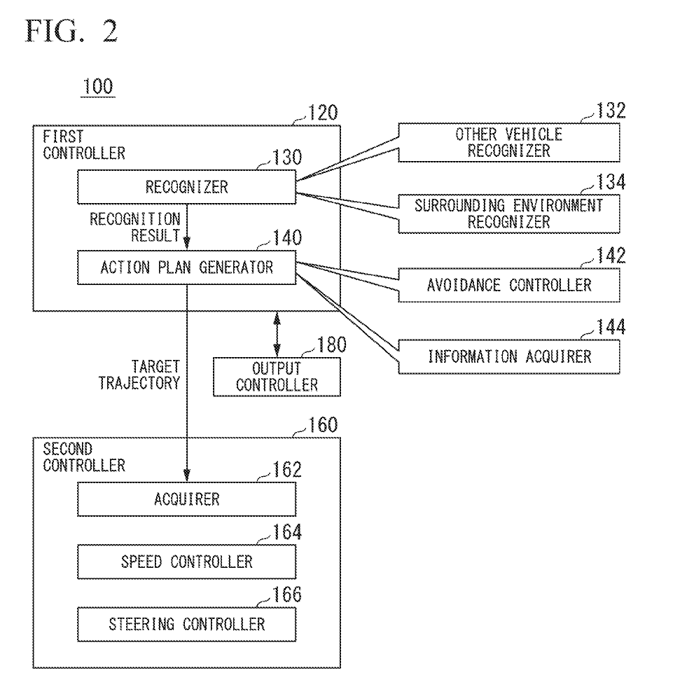

FIG. 2 is a functional configuration diagram of the first controller 120 and the second controller 160. The first controller 120 includes, for example, a recognizer 130 and an action plan generator 140. The first controller 120 realizes, for example, a function of artificial intelligence (AI) and a function of a previously given model in parallel. For example, a function of “recognizing an intersection” may be realized by performing recognition of an intersection by deep learning and the like and recognition based on previously given conditions (there are traffic signals, road markings, or the like with which pattern matching is possible) in parallel, and performing comprehensive evaluation by assigning scores to both the recognitions. As a result, the reliability of automatic driving is guaranteed.

On the basis of the information input from the camera 10, the radar device 12, and the finder 14 via the object recognition device 16, the recognizer 130 recognizes a state of an object in the vicinity of the host vehicle M such as the position, the speed, and the acceleration. The position of an object is recognized as a position on absolute coordinates with a representative point (a center of gravity, a drive axis center, or the like) of the host vehicle M set as an origin, and is used for control. The position of an object may be represented by a representative point such as the center of gravity or corner of the object, or may be represented by a representative region. The “state” of an object may include the acceleration or jerk of the object, or “behavior state” thereof (for example, whether lane change is being performed, or whether lane change is intended to be performed).

The recognizer 130 recognizes, for example, a lane (travel lane) on which the host vehicle M is traveling. For example, the recognizer 130 may recognize the travel lane by comparing a pattern of road lane markings obtained from the second map information 62 (for example, an arrangement of a solid line and a broken line) and a pattern of road lane markings around the host vehicle M recognized from an image captured by the camera 10. The recognizer 130 may recognize a travel lane by recognizing not only road lane markings but also a lane boundary (road boundary) including road lane markings, a road shoulder, a curb stone, a median strip, a guard rail, and the like. In this recognition, the position of the host vehicle M acquired from the navigation device 50 and a result of processing by INS may be added. The recognizer 130 recognizes temporary stop lines, obstacles, red lights, toll gates, road structures, other vehicles, and other road events.

The recognizer 130 recognizes the position and posture of the host vehicle M with respect to a travel lane when the travel lane is recognized. For example, the recognizer 130 may recognize a deviation from a lane center of a reference point of the host vehicle M and an angle formed with respect to a line connecting lane centers in the traveling direction of the host vehicle M as a relative position and a posture of the host vehicle M with respect to the travel lane. Alternatively, the recognizer 130 may also recognize the position and the like of the reference point of the host vehicle M with respect to either side end of the travel lane (road lane markings or a road boundary) as the relative position of the host vehicle M with respect to the travel lane.

The recognizer 130 includes, for example, an other vehicle recognizer 132 and a surrounding environment recognizer 134. The other vehicle recognizer 132 recognizes another vehicle entering into a road from outside the road. The other vehicle recognizer 132 recognizes a surrounding environment of another vehicle, and recognizes a factor of another vehicle entering into a road from outside the road. The surrounding environment recognizer 134 recognizes an environment such as a road structure of the surroundings in which another vehicle is stopped. Details of functions of the other vehicle recognizer 132 and the surrounding environment recognizer 134 will be described below.

In principle, the action plan generator 140 generates a target trajectory on which the host vehicle M automatically (without depending on an operation of a driver) travels in the future such that the host vehicle M travels on a recommended lane determined by the recommended lane determiner 61, and cope with the surrounding situation of the host vehicle M. A target trajectory includes, for example, a speed factor. For example, a target trajectory is expressed as a sequence of points (trajectory points) to be reached by the host vehicle M. A trajectory point is a point to be reached by the host vehicle M for each predetermined travel distance (for example, about several [m]) by road distance, and apart from this, the target speed and target acceleration for predetermined sampling times (for example, about every several tenths of a [sec]) are generated as a part of the target trajectory. The trajectory point may be a position to be reached by the host vehicle M at the sampling time for each predetermined sampling time. In this case, information on the target speed and the target acceleration is expressed with an interval between the trajectory points.

The action plan generator 140 may set events of automatic driving to generate a target trajectory. The events of automatic driving include a constant-speed travel event, a low-speed following travel event, a lane change event, a branch event, a confluence event, a takeover event, and the like. The action plan generator 140 generates a target trajectory according to an activated event, and includes an avoidance controller 142 and an information acquirer 144.

On the basis of results of the recognition by the other vehicle recognizer 132 and the surrounding environment recognizer 134, the avoidance controller 142 determines whether another vehicle m enters (proceeds) into a road from outside the road. The avoidance controller 142 determines whether to cause another vehicle m entering into the road from the outside the road to avoid the host vehicle M on the basis of results of the determination. Details of the function of the avoidance controller 142 will be described below. The information acquirer 144 acquires information on another vehicle via the communication device 20 (a communication unit) that communicates with another vehicle.

The second controller 160 controls the traveling driving force output device 200, the brake device 210, and the steering device 220 such that the host vehicle M passes through a target trajectory generated by the action plan generator 140 at a scheduled time.

The output controller 180 controls the outputter 90 at a timing instructed by the action plan generator 140 and outputs predetermined information.

Returning to FIG. 2, the second controller 160 includes, for example, an acquirer 162, a speed controller 164, and a steering controller 166. The acquirer 162 acquires information of a target trajectory (trajectory point) generated by the action plan generator 140, and causes it to be stored in a memory (not shown). The speed controller 164 controls the traveling driving force output device 200 or the brake device 210 on the basis of a speed factor associated with the target trajectory stored in the memory. The steering controller 166 controls the steering device 220 according to the curvature of the target trajectory stored in the memory. Processing of the speed controller 164 and the steering controller 166 is realized by a combination of feedforward control and feedback control. As an example, the steering controller 166 executes feedforward control in accordance with the curvature of a road in front of the host vehicle M in combination with feedback control based on the deviation from the target trajectory.

Returning to FIG. 1, the traveling driving force output device 200 outputs a traveling driving force (torque) for traveling of a vehicle to a drive wheel. The traveling driving force output device 200 includes, for example, a combination of an internal combustion engine, an electric motor, a transmission, and the like, and an ECU that controls them. The ECU controls the above constituents described above according to information input from the second controller 160 or information input from the driving operator 80. The combination of the action plan generator 140 and the second controller 160 is an example of a driving controller.

The brake device 210 includes, for example, a brake caliper, a cylinder for transmitting a hydraulic pressure to the brake caliper, an electric motor for generating a hydraulic pressure in the cylinder, and a brake ECU. The brake ECU controls the electric motor according to the information input from the second controller 160 or the information input from the driving operator 80 such that brake torque in accordance with a braking operation is output to each wheel. The brake device 210 may include, as a backup, a mechanism for transmitting a hydraulic pressure generated by an operation of a brake pedal included in the driving operator 80 to the cylinder via a master cylinder. The brake device 210 is not limited to as described above, and may also be an electronically controlled hydraulic pressure brake device that controls an actuator according to the information input from the second controller 160 and transmits a hydraulic pressure of the master cylinder to the cylinder.

The steering device 220 includes, for example, a steering ECU and an electric motor. The electric motor changes, for example, an orientation of steering wheels by applying force to a rack and pinion mechanism. The steering ECU drives the electric motor and changes the orientation of steering wheels according to the information input from the second controller 160 or the information input from the driving operator 80.

[Entrance and the Like of Another Vehicle Outside Road]

Hereinafter, processing in which the automated driving control device 100 determines whether to cause the host vehicle M to avoid another vehicle entering into a road from outside the road will be described. When the host vehicle travels through a trunk road or the like having a large traffic volume, in the traveling direction of the host vehicle, there are cases in which another vehicle enters the road from outside the road because there are shops and the like into or from vehicles enter or exit.

If another vehicle m stopping in an area outside the road starts moving and enters a road in which a host vehicle is traveling, there is a possibility that it may affect traveling of the host vehicle M. When there is another vehicle entering a road from outside the road, it is important to predict the movement of another vehicle and to cause the host vehicle M to travel smoothly.

The automated driving control device 100 determines whether another vehicle enters into a road from outside the road on the basis of the state of another vehicle recognized by the recognizer 130. If it is determined that the another vehicle enters into the road, the host vehicle M is caused to perform an avoidance operation. First, various types of recognition processing for causing the host vehicle M to perform this avoidance operation will be described.

[Function of Other Vehicle Recognizes]

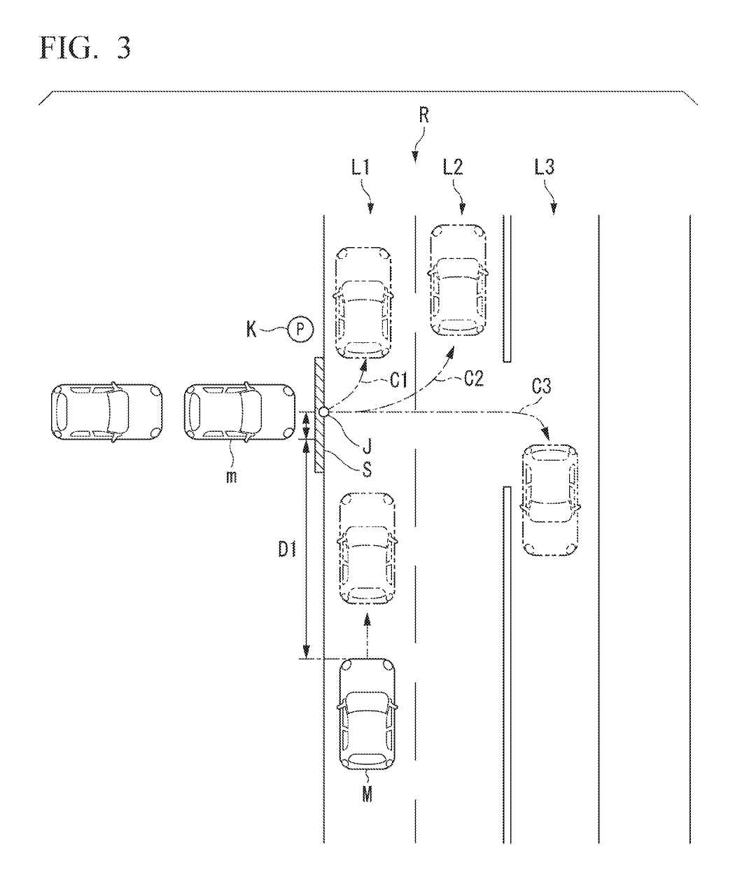

FIG. 3 is a diagram which shows an example of another vehicle m recognized by the other vehicle recognizer 132. As shown in FIG. 3, another vehicle m exists in an area W outside the road such as a trunk road. The other vehicle recognizer 132 recognizes, for example, another vehicle m existing in the area W outside the road R that faces the road. The other vehicle recognizer 132 extracts the road R and other objects on the basis of, for example, an image captured by the camera 10 or the like, and recognizes the state of another vehicle m. The other vehicle recognizer 132 may recognize vehicles stopping at an entrance/exit of a parking facility such as a sidewalk or a shop provided to be adjacent to the road R as another vehicle m or may also recognize vehicles including vehicles stopping on a road shoulder or the like as another vehicle m.

The other vehicle recognizer 132 also recognizes a preceding vehicle traveling in front of the host vehicle M and a following vehicle traveling behind the host vehicle M.

The other vehicle recognizer 132 recognizes, for example, an angle of the other vehicle m with respect to the traveling direction (an extending direction of a road) of the host vehicle M. The other vehicle recognizer 132 further recognizes an operation which is a factor of stopping another vehicle m entering into the road R.

The other vehicle recognizer 132 generates a three-dimensional model indicating a relative positional relationship between another vehicle m and the host vehicle M recognized at a certain time on the basis of, for example, an image captured by the camera 10. The other vehicle recognizer 132, for example, after proceeding to a certain extent, compares a position in a model of another vehicle m in a three-dimensional space, whose side viewed from the host vehicle m is changed, with a position in an image of another vehicle m acquired in advance, and recognizes or predicts an operation that the another vehicle m enters into a road R from an area outside the road R and a traveling direction thereof. The other vehicle recognizer 132 recognizes or predicts a traveling trajectory of another vehicle m, presence of absence of turning, a turning start point, a turning angle, and the like on the basis of the generated three-dimensional model.

The other vehicle recognizer 132 derives a posture of another vehicle m from an image captured by the camera 10, and derives a turning angle by comparing changes in the position and posture of the another vehicle m in a plurality of images in a predetermined sampling period. The other vehicle recognizer 132 recognizes a point at which the derived turning angle of the another vehicle m exceeds a threshold value as a turning start point. The other vehicle recognizer 132 recognizes an angle formed by an extending direction of the road R and the another vehicle m which is moving and stopping. In the example of FIG. 3, the other vehicle recognizer 132, based on the image captured by the camera 10, recognizes traveling trajectories C1, C2, and C3 of an approach destination of the another vehicle m proceeding or intending to proceed into the road R in the direction which intersects with the traveling direction of the host vehicle M.

The other vehicle recognizer 132 may perform the same processing as the processing for another vehicle m on a preceding vehicle traveling in front of the host vehicle M and a following vehicle traveling behind the host vehicle M.

The other vehicle recognizer 132 may communicate with another vehicle m when communication between the another vehicle m and a vehicle is possible, acquire information on operations of another vehicle such as activation, start moving, stop, and giving way of another vehicle m, and recognize the operations of another vehicle m.

[Function of Surrounding Environment Recognizes]

The surrounding environment recognizer 134 analyzes an image acquired by the camera 10, analyzes the image on the basis of a difference in luminance of the image, and recognizes the surrounding environment in which the another vehicle m is stopped. The surrounding environment recognizer 134 recognizes, for example, a place in which the another vehicle m is stopped.

The surrounding environment recognizer 134 recognizes a road structure around a position at which the another vehicle m is stopped.

The road structure is, for example, an artificially provided structure such as a median strip, a curb stone, and a sidewalk, and includes a pattern and the like written on a road surface such as lane marking. The surrounding environment recognizer 134 recognizes, for example, a curb stone extending at the left end of the road. The surrounding environment recognizer 134 recognizes an area extending along the road R adjacent to a left side of a curb stone as a sidewalk. The surrounding environment recognizer 134 recognizes, for example, a sidewalk provided as a structure.

In addition to the sidewalk provided as a structure, the surrounding environment recognizer 134 recognizes a roadside zone divided by a predetermined lane marking at the end of a road, and estimates the roadside zone as a sidewalk.

The surrounding environment recognizer 134 may further recognize an approach route S formed on the curb stone. The approach route S is a road structure that allows a vehicle to pass between the road R and the area W outside the road, which is provided on the curb stone. The approach route S is, for example, a slope having a break in the curb stone, and obtained by forming a height of a part of the curb stone lower than the other part, and a slope additionally installed on the road side adjacent to the curb stone.

The surrounding environment recognizer 134 may recognize a display content such as “P” displayed on a signboard K or the like indicating an entrance and exit of a parking lot existing outside a road, and recognize an area connected to the road R in the vicinity of the signboard K as an approach route S (an entrance and exit). The vicinity of the signboard K is, for example, an area within a predetermined distance from the signboard K, and the vicinity of the entrance and exit is a space connected to the entrance and exit, which is a positioned within a predetermined distance. The surrounding environment recognizer 134 may recognize an electric bulletin board, color coding of road surfaces and sidewalks, signs and the like written on road surfaces and sidewalks as well as the signboard K as indication of an entrance and exit.

In addition, the surrounding environment recognizer 134 may also recognize a state of a road surface of the road R road, such as being dry, wet, or frozen on the basis of a difference in luminance of an image captured by the camera 10.

[Function of Avoidance Controller]

Based on result of recognitions by the other vehicle recognizer 132 and the surrounding environment recognizer 134, the avoidance controller 142 determines whether another vehicle exists in an area outside the road, and causes the host vehicle M to decelerate or stop on the basis of a result of the determination. When the avoidance controller 142 determines that there is another vehicle m, it is determined whether the another vehicle m enters into the road from outside the road on the basis of a result of recognition of a state of the another vehicle m and a surrounding environment in which the another vehicle m is stopped.

When the avoidance controller 142 determines that the another vehicle m enters into the road on the basis of a result of the determination, the avoidance controller 142 controls the speed controller 164 and the steering controller 166 according to the state, entering route, and the like of the another vehicle m, and causes the host vehicle M to perform a predetermined avoidance operation. The avoidance operation is, for example, a deceleration operation that decelerates the host vehicle, including deceleration or stop. Deceleration includes increasing acceleration in a deceleration direction of the host vehicle or slowing down. The avoidance controller 142 decelerates or stops the host vehicle M to cause another vehicle to enter in front of the host vehicle.

In the example of FIG. 3, the other vehicle recognizer 132 recognizes another vehicle m existing in the vicinity of the approach route S recognized by the surrounding environment recognizer 134, and recognizes a distance between the another vehicle m and the host vehicle M and a direction of the another vehicle m with respect to the road R on the basis of the generated three-dimensional model. The vicinity of the approach route S is, for example, a space connected to the approach route S, which is positioned within a predetermined distance.

Based on the generated three-dimensional model, the other vehicle recognizer 132 predicts a first position J from which another vehicle m enters into a road in the approach route S. The first position J is, for example, an intersection point between a center line of the another vehicle m and a road end in the approach route S. The other vehicle recognizer 132 recognizes a first distance D1 which is a distance obtained by subtracting about 1 [m], which is a general half vehicle width of another vehicle, from a distance between the first position J and the position of the host vehicle M in a direction of a travel lane L1.

The avoidance controller 142 determines whether the first distance D1 is equal to or greater than a predetermined distance. The predetermined distance is, for example, a braking distance from when a brake starts to work until the host vehicle M stops or slows down. The braking distance is calculated using the speed of the host vehicle, limited deceleration (for example, about 0.2 [G]), reaction time, and the like on the basis of a predetermined formula. The avoidance controller 142 may use time until a host vehicle reaches a position a few meters in front of another vehicle m (or the first position J) instead of the predetermined distance. The avoidance controller 142 may appropriately change a value of the predetermined distance on the basis of a state of a road surface recognized by the surrounding environment recognizer 134 and a control value of the feedback control.

When the avoidance controller 142 determines that the first distance D1 is equal to or greater than the predetermined distance, it is determined whether the another vehicle m is moving in a direction of the travel lane L1. When the avoidance controller 142 determines that the another vehicle m is moving in the direction of the travel lane L1, it determines that the another vehicle m enters in front of the host vehicle M, and performs an avoidance control on the host vehicle M to cause the another vehicle m to enter in front of the host vehicle. The avoidance controller 142 causes the host vehicle M to decelerate or stop as the avoidance control, for example. When the avoidance controller 142 causes the host vehicle M to decelerate or stop, the avoidance controller 142 controls the host vehicle M such that the distance between the another vehicle m and the host vehicle M keeps at least a predetermined inter-vehicle distance not to be in contact with the another vehicle, while recognizing the position of the another vehicle m.

When it is determined that the another vehicle m is not moving in the direction of travel lane L1, the avoidance controller 142 determines that the another vehicle m does not enter in front of the host vehicle M and performs determination processing on the states of a following vehicle and the host vehicle M as described below. The state in which the another vehicle m is not moving in the direction of travel lane L1 includes a state in which the another vehicle m is stopped, a state in which the another vehicle m is moving in a direction opposite to the travel lane L1, and a state in which the another vehicle is traveling parallel to a road.

When the avoidance controller 142 determines that the another vehicle m is not moving in the direction of the travel lane L1, the avoidance controller 142 causes the host vehicle M to travel as it is without deceleration or stopping. It is because, when the another vehicle m is stopped, a driver of the another vehicle m is in a state of paying attention on a movement of the host vehicle M or in a state of no intention to move, and it is predicted that there is no other vehicles entering the travel lane L1 while the host vehicle M travels without deceleration.

When the avoidance controller 142 determines that the first distance D1 is less than the predetermined distance, the host vehicle M is caused to travel as it is without deceleration or stopping to prevent another vehicle m from entering. In this state, it is because the driver of another vehicle m is in the state of paying attention on the host vehicle M even if the host vehicle M is caused to travel as it is without deceleration or stopping, and it is predicted that the another vehicle m does not enter the travel lane L1.

However, even if the first distance D1 is less than the predetermined distance, there is a possibility that another vehicle enters the travel lane L1. When the first distance D1 is less than the predetermined distance, the avoidance controller 142 determines whether another vehicle proceeds or intends to proceed to the travel lane, and if it is determined that the another vehicle proceeds or intends to proceed, the avoidance controller 142 causes the host vehicle M to perform an avoidance operation such as lane change or sudden braking.

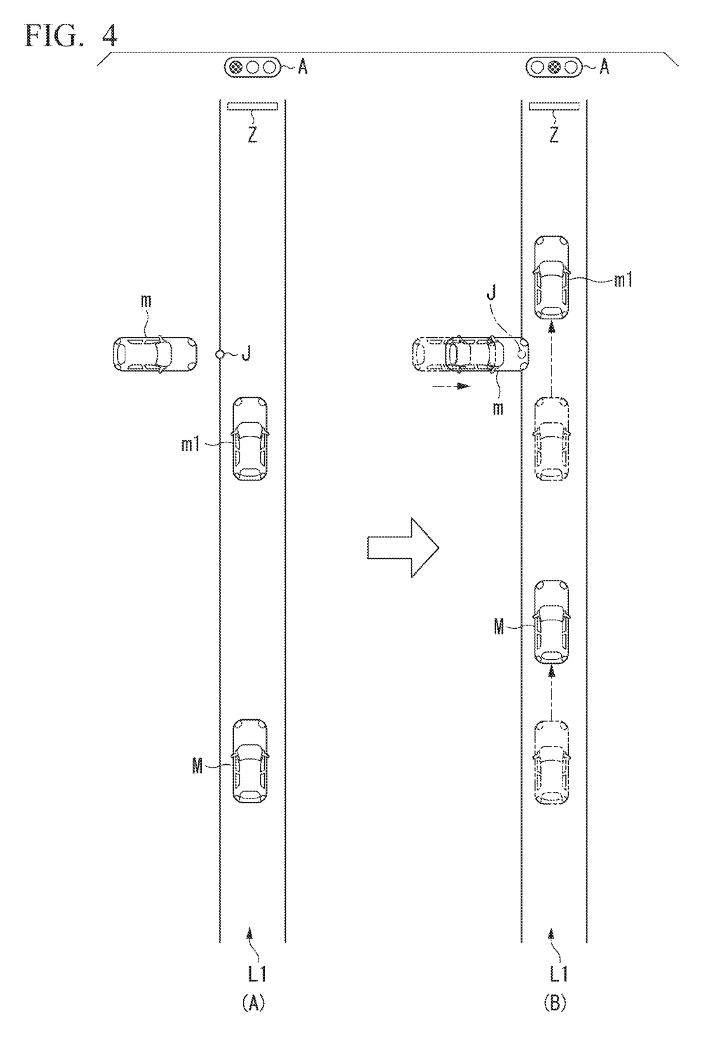

FIG. 4 is a diagram showing a state in which another vehicle m enters behind the preceding vehicle of the host vehicle M. As shown in FIG. 4(A), it is known that a preceding vehicle m1 travels in front of the host vehicle M and there is an opportunity that another vehicle m stopping in a direction substantially orthogonal to the traveling direction of the host vehicle M enters the travel lane L1. The avoidance controller 142 monitors the positional relationship between the preceding vehicle m1 and the another vehicle m.

The avoidance controller 142 determines whether another vehicle m enters the travel lane L1 on the basis of results of the recognitions by the other vehicle recognizer 132 and the surrounding environment recognizer 134. As shown in FIG. 4(B), after the preceding vehicle m1 traveling in front of the host vehicle M passes in front of another vehicle m, the another vehicle m may move toward the inside of a road.

The avoidance controller 142 determines that the another vehicle m enters in front of the host vehicle M when it is recognized that the another vehicle m moves toward the inside of a road after the preceding vehicle m1 passes in front of the another vehicle m. The avoidance controller 142 decelerates or stops the host vehicle M such that at least a predetermined inter-vehicle distance is kept between the another vehicle m and the host vehicle M not to be in contact with the another vehicle m, while recognizing the position of the another vehicle m.

When it is determined that the distance between the another vehicle m and the host vehicle M is a sufficient distance for keeping a predetermined inter-vehicle distance without decelerating or stopping the host vehicle M, the avoidance controller 142 may cause the host vehicle M to travel as it is.

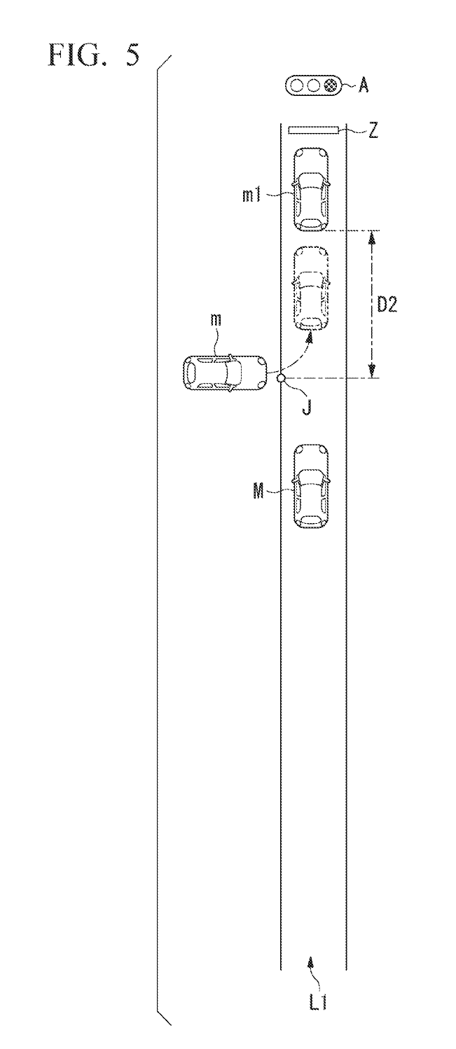

FIG. 5 is a diagram which shows an example of a state in which the preceding vehicle m1 stops after passing in front of another vehicle m. FIG. 5 shows a state in which the preceding vehicle m1 decelerates to slow down or stop due to such factors as display contents of a traffic light A turning into a red light after the preceding vehicle passes through the first position J. In this state, after the preceding vehicle m1 passes through the first position J, the preceding vehicle m 1 decelerates or stops in a state of leaving a distance at which a vehicle can enter in a second distance D2 between a stop position of the preceding vehicle m1 and the first position J.

When it is recognized that the preceding vehicle m1 traveling in front of the host vehicle M decelerates or stops within a threshold value from the first position J after passing through the first position J by the other vehicle recognizer 132 and the surrounding environment recognizer 134, the avoidance controller 142 causes the host vehicle to decelerate or stop such that the another vehicle m enters in front of host vehicle M.

To decelerate or stop the host vehicle such that the another vehicle m enters in front of the host vehicle M is to prompt the another vehicle m to enter in front of the host vehicle M by slowing down or stopping the host vehicle M to secure a distance at which the another vehicle m can enter between the host vehicle M and the preceding vehicle m1.

The other vehicle recognizer 132 recognizes the preceding vehicle m1 at a position at which it decelerates or stops from the first position J after passing through the first position J. The other vehicle recognizer 132 recognizes the second distance D2 between the stop position of the preceding vehicle m1 and the first position. The second distance D2 is, for example, a distance between a rear end of the preceding vehicle m1 and the first position J.

The avoidance controller 142 compares the second distance D2 with a threshold value and determines whether the second distance D2 is equal to or less than the threshold value. Here, the threshold value is a value set to secure a space at which another vehicle m can enter, and is a distance for the another vehicle m to follow the preceding vehicle m1 after entering into a road. The threshold value is, for example, a value obtained by adding a margin width to a distance of an entire length of a vehicle. The entire length of a vehicle may be an average value of the entire lengths of vehicles or may also be the entire length of the recognized another vehicle m. As the margin width, an average distance between vehicles of a train in a stop state may be used, or a predetermined value about 1 to 2 [m] may be set in advance.

The avoidance controller 142 determines whether the second distance D2 is equal to or less than the threshold value. When the avoidance controller 142 determines that the second distance D2 is equal to or less than the threshold value, it decelerates or stops the host vehicle such that another vehicle m enters in front of the host vehicle M. However, entering of another vehicle m in front of the host vehicle M includes that the another vehicle m stops after entering in front of the vehicle body in the travel lane L1. Therefore, for example, when the preceding vehicle m1 stops in a state in which the second distance D2 is shorter than the entire length of the another vehicle, the avoidance controller 142 stops the host vehicle M at a distance of about several [m] before the first position J, and prompts another vehicle m to enter the travel lane L1 when the preceding vehicle m1 starts moving again.

When the avoidance controller 142 determines that the second distance D2 is greater than the threshold value, the host vehicle M is caused to follow behind the preceding vehicle m1 or to travel as it is. To cause the host vehicle M to follow behind the preceding vehicle m1 includes causing the host vehicle to stop behind the preceding vehicle m1. With such processing, the another vehicle m enters the travel lane L1 behind the host vehicle M, and the host vehicle M is prevented from excessively driving to give way to vehicles in an intersecting direction.

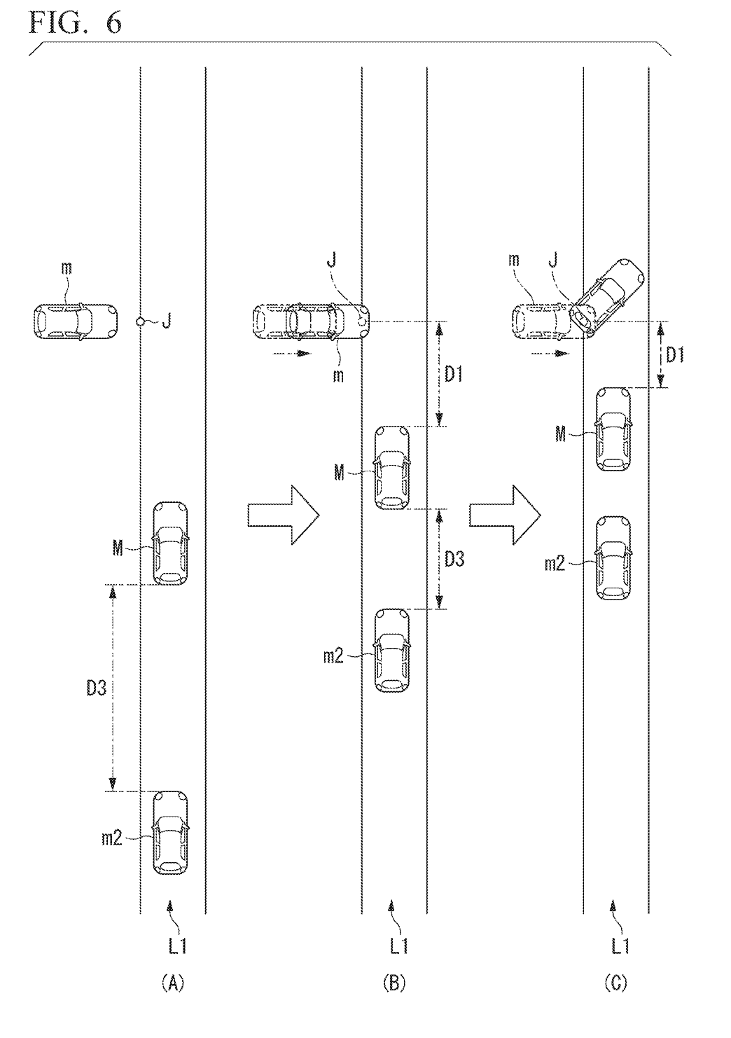

FIG. 6 is a diagram which shows a state in which a following vehicle m2 of the host vehicle M and another vehicle m exist. As shown in FIG. 6(A), when there is the following vehicle m2 of the host vehicle M, the avoidance controller 142 determines whether to cause the host vehicle M to decelerate or stop according to a third distance D3 between the following vehicle m2 and the host vehicle M. The third distance D3 is, for example, a distance between a rear end of the host vehicle M and a front end of the following vehicle m2.

When another vehicle m is recognized outside a road and is determined to enter into the road, the avoidance controller 142 determines whether the following vehicle m2 is traveling behind the host vehicle M. When the avoidance controller 142 determines that the following vehicle m2 is traveling behind the vehicle M, it determines whether the third distance D3 between the following vehicle m2 and the host vehicle M is equal to or greater than a predetermined distance.

Here, the predetermined distance is a distance set such that the another vehicle m does not collide with the host vehicle M even if the another vehicle m follows the host vehicle M to decelerate or stop when the host vehicle M performs an avoidance operation such as deceleration or stopping. The predetermined distance is a distance at which the following vehicle m2 can decelerate or stop to a creeping speed at an acceleration equal to or less than a threshold value that does not give a sense of discomfort to occupants without using a sudden braking. In addition to this, instead of using the predetermined distance, time until the following vehicle m2 reaches a position separated from the behind of the host vehicle M by about several [m] may be used.

When the avoidance controller 142 determines that the third distance D3 between the following vehicle m2 and the host vehicle M is equal to or greater than the predetermined distance, the avoidance controller 142 causes the host vehicle M to decelerate or stop. As shown in FIG. 6(B), the avoidance controller 142 causes the host vehicle M to decelerate not to be in contact with the another vehicle m and the following vehicle m2 while monitoring the first distance D1 and the third distance D3 on the basis of a three-dimensional model generated using an image captured by the camera 10.

As shown in FIG. 6(C), the avoidance controller 142 stops or slows down the host vehicle M at a position at which the host vehicle M and the first position J are separated by a distance of about several [m] or more, and causes the host vehicle M to decelerate such that the following vehicle m2 and the host vehicle M are separated by a distance of about several [m]. When the avoidance controller 142 determines that the third distance D3 between the following vehicle m2 and the host vehicle M is less than the predetermined distance, it causes the host vehicle M to travel as it is.

When the avoidance controller 142 causes the host vehicle to decelerate or stop, the avoidance controller 142 instructs the output controller 180 to output information for prompting another vehicle to enter into a road via the outputter 90. The information to be output includes, for example, lighting of passing light by causing a high beam to flicker, warning of horn, announcement of a voice message such as “please go in front”, and transmission of information indicating “give way” by vehicle-to-vehicle communication in addition to information display by a text such as “please go in front” to an external display device and the like.

The avoidance controller 142 may change a degree of avoidance control of the host vehicle M by a driving mode of automatic driving of the host vehicle M. In this case, the driving mode includes, for example, at least a first mode in which the host vehicle normally travels and a second mode with a higher degree of avoidance control than the first mode.

The first mode is a mode in which another vehicle is caused to enter when, for example, an entering speed of another vehicle, an acceleration thereof, and a distance to the another vehicle satisfy a first predetermined condition. The second mode is a mode in which the host vehicle travels on a second predetermined condition obtained by relaxing the first predetermined condition for causing another vehicle to easily enter. To relax the first predetermined condition is, for example, to decrease the entering speed or acceleration as compared with the first mode, and to shorten the distance to another vehicle as compared with the first mode.

When another vehicle is recognized by the recognizer 130 while the host vehicle travels in the second mode, the avoidance controller 142 causes the host vehicle to decelerate or stop such that the another vehicle enters in front of the host vehicle on the basis of the second predetermined condition.

[Processing Flow]

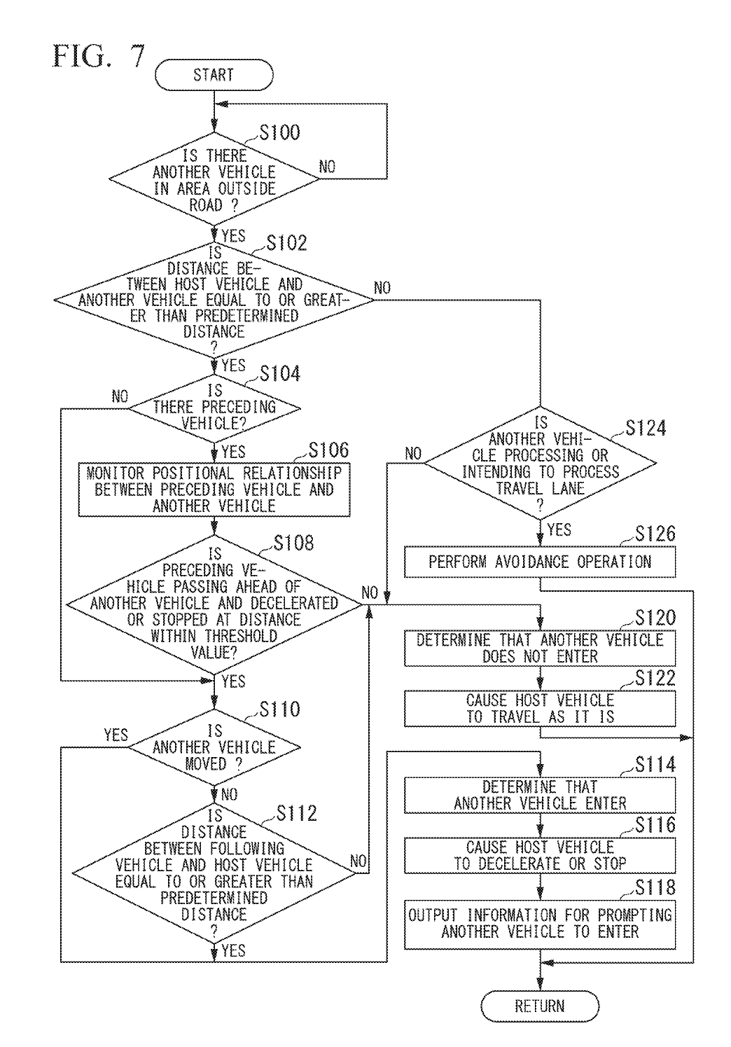

Next, a flow of processing executed in the automated driving control device 100 will be described. FIG. 7 is a flowchart which shows an example of a flow of processing executed in the automated driving control device 100. Based on a result of the recognition by the other vehicle recognizer 132, the avoidance controller 142 determines whether there is another vehicle m in an area outside a travel lane on which the host vehicle M is traveling (step S100). When a negative determination is obtained in step S100, the avoidance controller 142 repeats the processing of step S100 until another vehicle is recognized.

When a positive determination is obtained in step S100, the avoidance controller 142 determines whether a distance between the host vehicle and the another vehicle is equal to or greater than a predetermined distance (step S102). When a positive determination is obtained in step S102, the avoidance controller 142 determines whether there is a preceding vehicle in the travel lane on which the host vehicle travels (step S104). When a negative determination is obtained in step S104, the avoidance controller 142 advances the processing to step S110. When a positive determination is obtained in step S104, the avoidance controller 142 monitors a positional relationship between the preceding vehicle and the another vehicle (step S106).

Next, the avoidance controller 142 determines whether the preceding vehicle has decelerated or stopped at a distance within a threshold value after passing in front of the another vehicle (step S108). When a positive determination is obtained in step S108, the avoidance controller 142 determines whether the another vehicle has moved in a direction of the travel lane (step S110). When a positive determination is obtained in step S110, the avoidance controller 142 advances the processing to step S114.

When a negative determination is obtained in step S110, the avoidance controller 142 determines whether the distance between the following vehicle and the host vehicle is equal to or greater than a predetermined distance (step S112). When a positive determination is obtained in step S112, it is determined that the another vehicle enters in front of the host vehicle (step S114). Next, the avoidance controller 142 causes the host vehicle to decelerate or stop such that the another vehicle enters in front of the host vehicle (step S116).

The avoidance controller 142 instructs the output controller 180 to output information for prompting another vehicle to enter into a road at the time of decelerating or stopping the host vehicle to the outputter 90 (step S118).

When a negative determination is obtained in step S102, the avoidance controller 142 determines whether the another vehicle proceeds or intends to proceed in a direction intersecting with the traveling direction of the host vehicle on the travel lane (step S124). When a positive determination is obtained in step S124, the avoidance controller 142 causes the host vehicle M to perform an avoidance operation such as lane change or sudden braking (step S126).

When negative determinations are obtained in step S108, step S112, and step S124, the avoidance controller 142 determines that the another vehicle does not enter (step S120). Next, the avoidance controller 142 causes the host vehicle to travel as it is (step S122). When there is no following vehicle in step S112, the avoidance controller 142 determines that the distance between the following vehicle and the host vehicle is equal to or greater than a predetermined distance. Thereafter, the avoidance controller 142 ends the processing of the flowchart.

In the flowchart described above, an order of respective steps is not limited to this, and may be replaced as appropriate. In the flowchart described above, it is determined that another vehicle enters into a road when one condition is satisfied. However, instead of this, it may also be determined that another vehicle enters into the road when a plurality of conditions are satisfied.

According to the embodiment described above, the automated driving control device 100 can cause the host vehicle to travel smoothly in various aspects.

[Hardware Constituent]

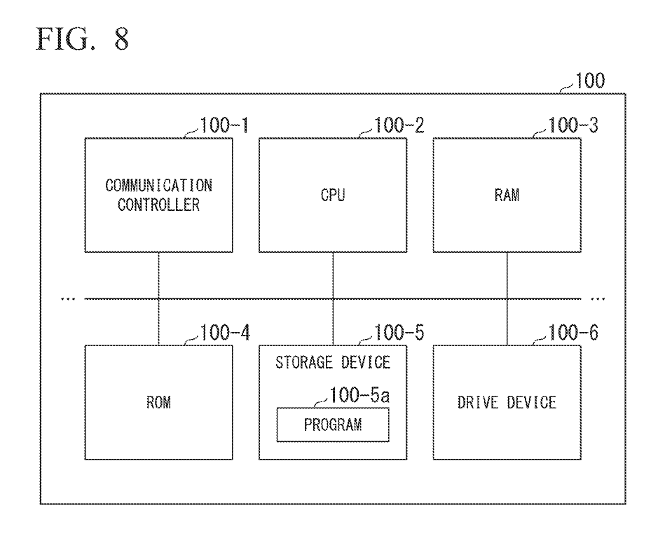

FIG. 8 is a diagram which shows an example of hardware constituents of the automated driving control device 100 according to the embodiment. As shown in FIG. 8, the automated driving control device 100 includes a communication controller 100-1, a CPU 100-2, a random access memory (RAM) 100-3 used as a working memory, a read only memory (ROM) 100-4, a storage device 100-5 such as a flash memory or a hard disk drive (HDD), a drive device 100-6, and the like, which are connected to one another by an internal bus or a dedicated communication line.

The communication controller 100-1 communicates with components other than the automated driving control device 100. In the storage device 100-5, a program 100-5a executed by the CPU 100-2 is stored. This program is developed in the RAM 100-3 by a direct memory access (DMA) controller (not shown) or the like and executed by the CPU 100-2.

As a result, some or all of the other vehicle recognizer, the surrounding environment recognizer, the avoidance controller, the information acquirer, and the output controller are realized.

The embodiment described above can be expressed as follows.

A vehicle control device includes a storage device storing a program, and a hardware processor, in which the hardware processor executes the program stored in the storage device, thereby recognizing a surrounding situation of a host vehicle, controlling acceleration or deceleration and steering of the host vehicle on the basis of the recognized surrounding situation, recognizing another vehicle proceeding or intending to proceed in a first direction intersecting with a traveling direction of the host vehicle, determining whether the another vehicle enters in front of the host vehicle on the basis of a movement of the recognized another vehicle proceeding or intending to proceed in the first direction, and decelerating or stopping the host vehicle when it is determined that the another vehicle enters in front of the host vehicle.

As described above, although a mode for carrying out the present invention have been described using an embodiment, the present invention is not limited to the embodiment, and various modifications and substitutions can be added within a scope not departing from the gist of the present invention. For example, the avoidance operation that is required when another vehicle enters from an area outside a road on a left side of the road has been described in the embodiment described above; however, the present invention is not limited to this and may be applied to avoidance control when another vehicle enters from an intersection road without traffic light, which is connected to the travel lane from the left side. Furthermore, the present invention may be applied to avoidance control when another vehicle located on a side of an opposite lane enters the travel lane from the right side.

What is claimed is:

1. A vehicle control device comprising:
a recognizer configured to recognize a surrounding situation of a host vehicle; and
a driving controller configured to control acceleration or deceleration and steering of the host vehicle on the basis of a surrounding situation recognized by the recognizer,
wherein the recognizer recognizes another vehicle proceeding or intending to proceed in a first direction which intersects with a traveling direction of the host vehicle, and
the driving controller determines whether another vehicle proceeding or intending to proceed in the first direction enters in front of the host vehicle on the basis of a movement of the another vehicle, and causes the host vehicle to decelerate or stop when it is determined that the another vehicle enters in front of the host vehicle.

2. The vehicle control device according to claim 1,
wherein, when the recognizer recognizes that the another vehicle proceeding or intending to proceed in the first direction has moved after a preceding vehicle traveling in front of the host vehicle passes in front of the another vehicle, the driving controller determines that the another vehicle enters in front of the host vehicle, and causes the host vehicle to decelerate or stop.

3. The vehicle control device according to claim 1,
wherein, when the recognizer recognizes that the another vehicle proceeds and a distance between a first position at which the another vehicle is predicted to enter into a road and the host vehicle is equal to or greater than a predetermined distance, the driving controller determines that the another vehicle enters in front of the host vehicle and causes the host vehicle to decelerate or stop.

4. The vehicle control device according to claim 3,
wherein, when it is determined whether to cause a preceding vehicle traveling in front of the host vehicle to decelerate or stop within a predetermined distance from the first position after the preceding vehicle passes through the first position, and a positive determination is obtained by the recognizer, the driving controller causes the host vehicle to decelerate or stop such that the another vehicle enters in front of the host vehicle.

5. The vehicle control device according to claim 1,
wherein the driving controller determines whether to decelerate or stop the host vehicle according to a distance between a following vehicle traveling behind the host vehicle and the host vehicle.

6. The vehicle control device according to claim 1, further comprising:
an outputter configured to output information,
wherein the driving controller outputs information prompting the another vehicle to enter in front of the host vehicle via the outputter at the time of causing the host vehicle to decelerate.

7. The vehicle control device according to claim 3,
wherein, when the recognizer recognizes another vehicle in a state in which the another vehicle travels in a second mode in which a second predetermined condition is set to make it easier to cause the another vehicle to enter than in a first mode in which the another vehicle is caused to enter when a first condition is satisfied, the driving controller causes the host vehicle to decelerate or stop such that the another vehicle enters in front of the host vehicle on the basis of the second predetermined condition.

8. A vehicle control method which causes a computer to
recognize a surrounding situation of a host vehicle,
control acceleration or deceleration and steering of the host vehicle on the basis of a recognized surrounding situation,
recognize another vehicle proceeding or intending to proceed in a first direction which intersects with a traveling direction of the host vehicle,
determine whether the another vehicle enters in front of the host vehicle on the basis of a movement of the recognized another vehicle proceeding or intending to proceed in the first direction, and
decelerate or stop the host vehicle when it is determined that the another vehicle enters in front of the host vehicle.

9. A computer-readable non-transitory storage medium which stores a program causing a computer to
recognize a surrounding situation of a host vehicle,
control acceleration or deceleration and steering of the host vehicle on the basis of a recognized surrounding situation,
recognize another vehicle proceeding or intending to proceed in a first direction which intersects with a traveling direction of the host vehicle,
determine whether the another vehicle enters in front of the host vehicle on the basis of a movement of the recognized another vehicle proceeding or intending to proceed in the first direction, and
cause the host vehicle to decelerate or stop when it is determined that the another vehicle enters in front of the host vehicle.
